(19) United States
(12) Patent Application Publication
(10) Pub. No.: US 2007/0247868 A1
(43) Pub. Date: Oct. 25, 2007

(54) Light string

(75) Inventor: Zhaoyuan Li, Heyuan (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Cindex Holdings Limited

(21) Appl. No.: 11/407,852

(22) Filed: Apr. 20, 2006

(30) Foreign Application Priority Data
Apr. 19, 2006 (CN) 20060074840.8

(51) Int. Cl. F21S 4/00

(52) U.S. Cl. 362/565

(57) ABSTRACT

A light string, which can be used for decorative purposes during holidays, is provided. In one embodiment, the light string includes a plurality of input terminals adapted to receive power from a voltage source; a plurality of light assemblies, wherein at least one of the plurality of light assemblies is electrically connected to at least one of the plurality of input terminals, each light assembly including at least two lights electrically connected in series; and at least one bidirectional voltage regulator diode, wherein the combination of the at least one bidirectional voltage regulator diode is connected in parallel to the at least two series connected lights and functions as an electrical shunt for the at least two lights.

### CROSS-REFERENCE TO RELATED APPLICATION (S)

This Application claims priority to Chinese Application No. ______, filed on Apr. 19, 2006, the contents of which are incorporated in its entirety by reference herein.

### FIELD OF THE INVENTION

The present invention relates generally to an electric circuit with a plurality of loads, and more particularly, the invention relates to a circuit used for a string of lights.

### BACKGROUND OF THE INVENTION

Light strings are generally used for decorative purposes during holidays. Typical light strings are arranged with lights being electrically connected in series, rather than in a parallel arrangement. With a typical series arrangement, if one light burns out or is removed from a socket, the entire series of lights will extinguish. This is because each individual light completes the electrical circuit, and when a light burns out or is removed, it creates an open circuit which prevents the flow of current to the remaining lights on the string. In order to fix this problem, light strings have been developed that utilize various types of shunts in parallel with the light, so that the light string will continue to be lit if a light burns out or is removed. An example of a patent describing such a shunt is U.S. Pat. No. 6,580,182 which describes the use of back-to-back Zener diodes in parallel with each individual light. This shunt arrangement, however, is expensive due to the amount of diodes used and the extensive wiring required for the shunt arrangement. Therefore, a more cost efficient shunt arrangement for light strings is desired.

### BRIEF SUMMARY OF THE INVENTION

In one embodiment of the present invention, a light string is provided which comprises a plurality of input terminals adapted to receive power from a voltage source; a plurality of light assemblies, wherein at least one of the plurality of light assemblies is electrically connected to at least one of the plurality of input terminals, each light assembly including: at least two lights electrically connected in series; and at least one bidirectional voltage regulator diode in an inverse electrical series connection, wherein the combination of the at least one bidirectional voltage regulator diode is connected in parallel to the at least two series connected lights and functions as an electrical shunt for the at least two lights.

In one embodiment, the at least one diode is a Zener diode.

Further in one embodiment, the at least one bidirectional voltage regulator diode has voltage ratings so that when one or more of the at least two lights is burned out, there is not a reduced current flow or an undesired increase in current flow in the light string. Or variation in the current is very small, so that the function and life span of the remaining lights will not be affected.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an electrical schematic diagram of a light string.

### DETAILED DESCRIPTION OF THE INVENTION

The present invention is directed to a light string that generally prevents all of the lights in the light string from extinguishing when one of the lights burns out or is removed.

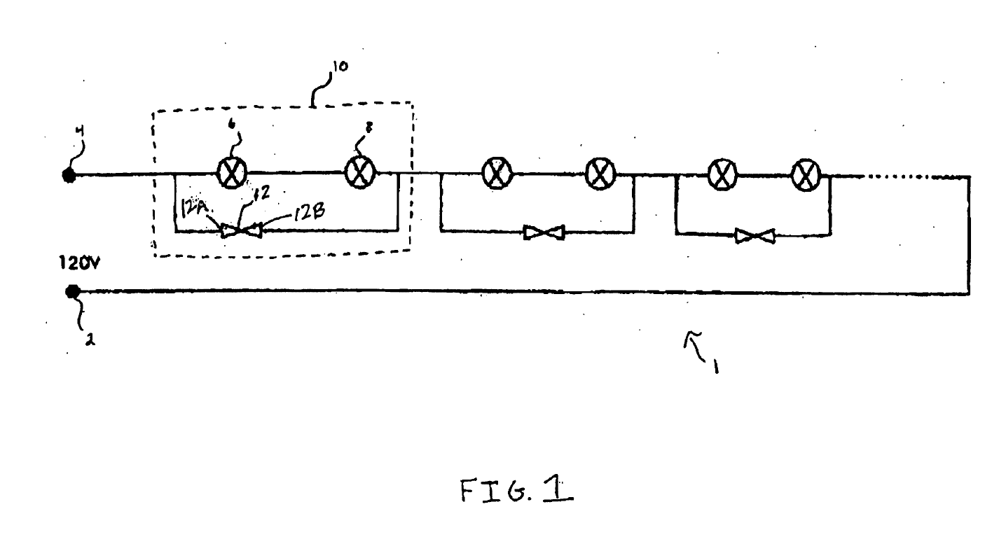

FIG. 1 is an electrical schematic diagram of a light string 1. Light string 1 comprises a first input terminal 2, a second input terminal 4 and a plurality of light assemblies 10. Input terminals 2, 4 are adapted to be connected to a voltage source. In one embodiment, the voltage source is 110/120 volts of alternating current (AC) traditionally found in a typical household or business. Light assemblies 10 comprise at least two lights and at least one bidirectional voltage regulator diode. In this embodiment, light assembly 10 comprises a first light 6 a second light 8, a bidirectional voltage regulator diode 12. Second input terminal 4 is electrically connected to first light 6 and one terminal 12A of the bidirectional voltage regulator diode 12. First light 6 is electrically connected to second light 8 in a series configuration. Second light 8 is electrically connected to the other terminal 12B of the bidirectional voltage regulator diode 12 and another light assembly that makes up a chain of light assemblies that comprise light string 1.

The bidirectional voltage regulator diode in the circuit connection of a series light string is in parallel with the series connection of first light 6 and second light 8. This parallel connection operates as a shunt so that if first light 6 or second light 8 burns out, the rest of the light assemblies in light string 1 still receive power from input terminals 4 and the two terminals 12A and 12B of the bidirectional voltage regulator diode 12 and remain lit. During normal operation of the light string, substantially no current flows through the two terminals 12A and 12B of the bidirectional voltage regulator diode and substantially all of the current flows through the series connected first and second lights 6, 8.

If first light 6 burns out or is being removed, an open circuit is formed. The voltage across the area of the burned out or removed light begins to rise toward the value of the applied line voltage. The bidirectional voltage regulator diode limits the amount of voltage across the area of the burned out or removed light because as the voltage increases bidirectional voltage regulator diode 12 begins to conduct. When the bidirectional voltage regulator diode is conducting it is in the “on” condition and allows current to pass through it. When the bidirectional voltage regulator diode is not conductive it is in the “off” condition and has a substantially high impedance and substantially does not allow current to pass through it. In one embodiment, 12 is a bidirectional Zener diode. In another embodiment, the bidirectional voltage regulator diode when conducting has an impedance near that of the series equivalent of first and second lights 6, 8. Assuming for illustrative purposes only, the bidirectional voltage regulator diode 12 in this embodiment is a bidirectional Zener diode with a 5V voltage rating Where one of first light 6 and second light 8 burns out or is being removed from the socket, the voltage across the two terminals of the bidirectional voltage regulator diode 12 increases rapidly. When the voltage reaches beyond 5V, the bidirectional voltage regulator diode 12 begins to conduct, such that current from the power source will flow through the bidirectional voltage regulator diode 12, allowing the circuit to continue to function properly. At this time, the bidirectional voltage regulator diode has an impedance equals to that of the series equivalent of first light 6 and second light 8. The bidirectional voltage regulator diode 12 when conducting has an approximate effective voltage breakdown rating of 5 volts. Bidirectional Zener diodes of various voltage ratings can be chosen so that when a light is burned out, there is not a reduced current flow or an undesired increase in current flow in the light string 1.

By utilizing one bidirectional voltage regulator diode for two or more lights rather than utilizing bidirectional voltage regulator diode for each light, the cost of diodes per light string 1 is greatly reduced, the quantity of diodes can be reduced by 50%. Also, the electrical connections (wiring, soldering, etc.) is substantially reduced, saving time and money, first by saving time for assembly, secondly by saving 50% of the diode material cost. Thirdly, bidirectional voltage regulator diodes can be used directly in an alternating current environment (hence no need to equip the light string with a commutator), its two terminals can be fitted at will without regard to the plus-minus polarity of the power source. This further facilitates manufacturing and ensures the product will work properly.

Although the invention has been described with reference to embodiments, persons skilled in the art will recognize that changes may be made in form and detail without departing from the spirit and scope of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

1. A light string comprising:
a plurality of input terminals adapted to receive power from a voltage source;
a plurality of light assemblies, wherein at least one of the plurality of light assemblies is electrically connected to at least one of the plurality of input terminals, each light assembly including:
at least two lights electrically connected in series; and
at least one bidirectional voltage regulator diode,
wherein the combination of the at least one bidirectional voltage regulator diode is connected in parallel to the at least two series connected lights and functions as an electrical shunt for the at least two lights.

2. The light string of claim 1, wherein the at least one bidirectional voltage regulator diode is a bidirectional Zener diode.

3. The light string of claim 1, wherein the at least one bidirectional voltage regulator diode has voltage ratings so that when one or more of the at least two lights is burned out, there is not a reduced current flow or an undesired increase in current flow in the light string.
